(19) United States
(12) Patent Application Publication
(10) Pub. No.: US 2011/0064587 A1
(43) Pub. Date: Mar. 17, 2011

(54) LOW WASTE PUMP FOLLOWER

(75) Inventors: William Hoversten, Stow, OH (US); Jerry Peters, LaGrange, OH (US); Mario Romanin, Valley City, OH (US)

(73) Assignee: NORDSON CORPORATION, Westlake, OH (US)

(21) Appl. No.: 12/872,634

(22) Filed: Aug. 31, 2010

Related U.S. Application Data
(60) Provisional application No. 61/243,267, filed on Sep. 17, 2009.

(51) Int. Cl. F04B 49/00; F15D 1/00

(52) U.S. Cl. 417/53; 137/565.01

(57) ABSTRACT

A low waste pump follower includes a platen and a perforated member. The platen has a bottom side defining a cavity and the perforated member covers the cavity. The pump follower is driven into a container of viscous material. Material is forced through the perforated member, into the cavity, and pumped to a dispenser. When the pump follower reaches the bottom of the container, it is retracted, and the residual material present in the cavity is retained by the perforated member.

### CROSS-REFERENCE TO RELATED APPLICATION

This application claims the priority of U.S. Provisional Patent Application Serial No. 61/243,267, filed on Sep. 17, 2009 (pending), the disclosure of which is incorporated by reference herein.

### TECHNICAL FIELD

The present invention generally relates to pump followers of the type used for removing viscous material from a container.

### BACKGROUND

Pump followers used in conjunction with pumps to remove viscous material from containers may generally include a circular plate or platen coupled to the inlet end of a pump. Such followers are inserted into the open end of a drum, barrel, or other container of highly viscous material. The viscous material is often stored in 55-gallon drums. The platen is driven toward the bottom of the drum. The viscous material is thereby forced into a cavity on the bottom side of the platen and through a pump intake passage in the center of the platen. The material is then pumped to a suitable dispenser.

There are shortcomings with the conventional pump followers. First, significant waste can occur as the pump follower is unable to capture all of the material within the drum. It is estimated that as much as 2-3 gallons of material per 55 gallon barrel can be lost due to this inefficiency. In a large scale operation, this translates into substantial material loss. Further, the leftover or residual material at the bottom of the barrel can pose disposal problems

For environmental reasons, liner bags are now frequently used to hold the material in the container. When the follower enters the container, it extracts the viscous material within the liner bag. The follower typically must remain spaced far enough from the bottom of the container that the liner bag does not become suctioned into the follower and pump intake passage. For example, in many applications of this type, the follower must be stopped at about 3″ from the bottom of the drum or container, leaving the material in this 3″ space as waste material in the liner bag.

### SUMMARY

In one illustrative embodiment of the present invention, a pump follower is provided that includes a perforated member, such as a screen or grid, attached across the bottom side of a platen. The perforated member covers a cavity of the platen that receives the viscous material and communicates with an intake passage in fluid communication with a pump. The perforated member is configured such that when the platen is inserted into a container of viscous material, the viscous material will flow through holes in the perforated member and into the cavity. The hole size(s) is/are chosen in conjunction with the viscosity of the material such that when the platen is retracted from the container, residual material will be trapped in the cavity and the intake passage by the perforated member. That is, the viscous material will not fall back through the holes in the perforated member into the container. Instead, it will be suctioned from the pump follower during the process of removing material from a subsequent container. In this manner, when the follower reaches the bottom of each container, it is able to capture almost all of the material stored within the container and reduce wasted material.

In another exemplary embodiment of the present invention, a method of capturing viscous material in a follower includes driving a platen into the viscous material. The viscous material flows through a perforated member and into a cavity of the platen. The platen is then retracted, and the material remaining in the cavity is retained in the cavity by the perforated member.

Various additional features and aspects of the embodiments and scope of the invention will be more readily appreciated upon review of the following detailed description of the illustrative embodiments taken in conjunction with the accompanying drawings.

### BRIEF DESCRIPTION OF THE DRAWINGS

FIG. 1 is a bottom perspective view of a pump follower constructed in accordance with an illustrative embodiment of the invention.

FIG. 2 is a cross-sectional view of the follower, taken along line 2-2 of FIG. 1.

FIG. 3 is an exploded bottom perspective view of the pump follower.

### DETAILED DESCRIPTION OF THE ILLUSTRATIVE EMBODIMENTS

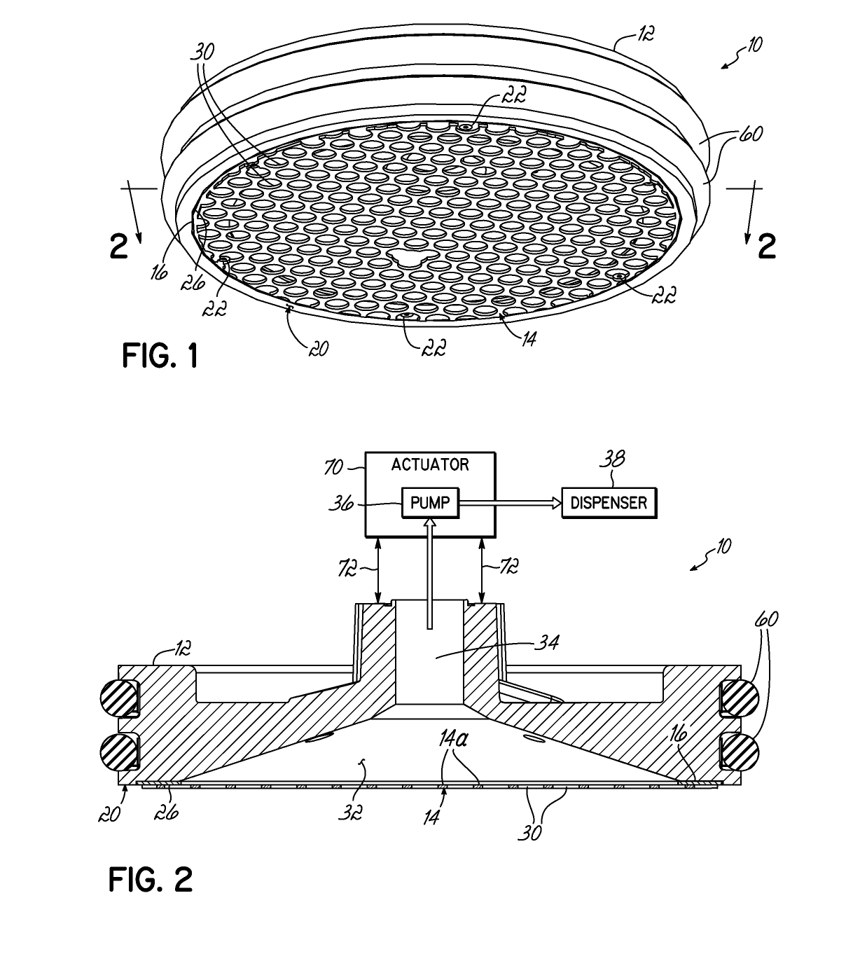

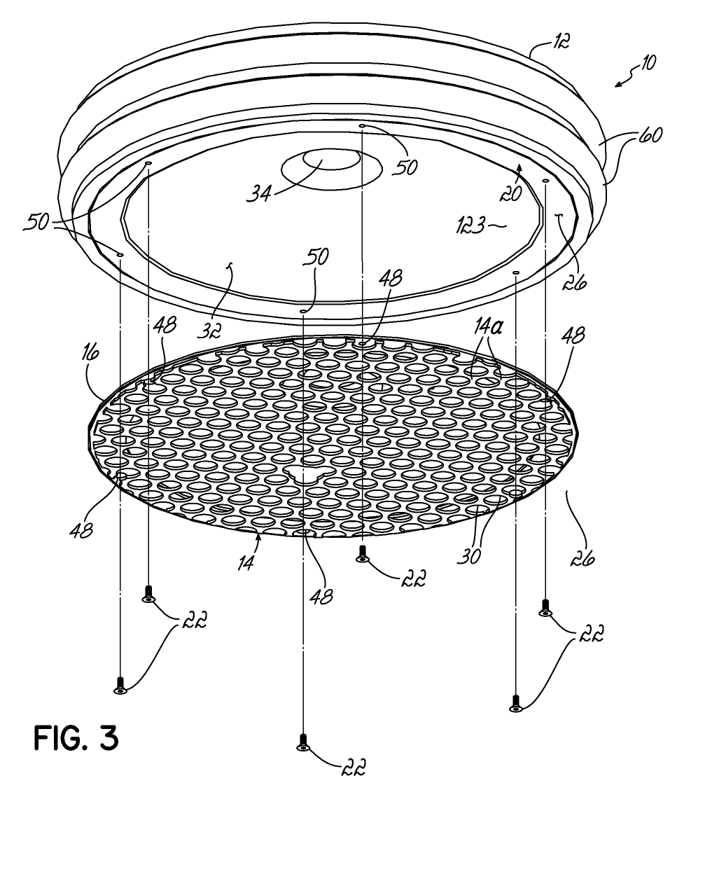

FIGS. 1-3 illustrate a pump follower 10 including a platen 12, a perforated member 14, and a mounting ring 16. The perforated member 14 is securely attached to the mounting ring 16, such as by welding. As another option, the perforated member and mounting ring may be substituted with a one- piece structure comprised, for example, of a plate having an outer, solid ring portion and an inner area of perforations. The perforated member 14 is mounted to a bottom side or face 20 of the platen 12 and is situated in a mounting rim or recess 26 (FIGS. 2 and 3) of the platen 12. Optionally, the recess 26 may be eliminated and the perforated member 14 secured to the bottom face of the platen 12. The mounting ring 16 is secured to the bottom face 20 of the platen 12, within recess 26, by threaded fasteners 22. Fasteners 22 may each comprise any element suitable for rigidly anchoring the mounting ring 16 to the mounting rim 26. Alternatively, any other manner of fastening the perforated member 14 to the platen 12 may be used. The perforated member 14 includes a plurality of holes 30 and comprises a perforated flat plate in this example, but may instead comprise any other suitable perforated member, such as a flat screen or grid of intersecting wire-like elements or the like.

As depicted in FIG. 2, the platen 12 has an internal cavity 32 located on the bottom side 20 of the platen 12. A pump intake passage 34 is located centrally within cavity 32 and communicates with a pump 36. The pump 36 communicates with at least one dispenser 38 for dispensing the fluid in any desired manner.

FIG. 3 illustrates an exploded view of the perforated member 14 and platen 12. The follower 10 is assembled as a unit by rigidly attaching the mounting ring 16 to the platen 12. The perforated member 14 positioned over and covers the entirety of the internal cavity 32 of the platen 12 and the mounting ring 16 is fastened to the platen 12 as discussed above. The mounting ring 16 includes plurality of mounting holes 48, each of the mounting holes corresponding to one of a plurality tapped mounting holes 50 formed in the mounting rim 26 of the platen 12 for receiving the fasteners 22.

The follower 10 is designed for use with viscous materials, such as glues, sealants, mastics, caulks, epoxies or other viscous material. A material pumped with follower 10 may have a viscosity of at least about 10,000 centipoise at room temperature. The holes 30 in the illustrated embodiment, are 1″ diameter holes staggered on 1¼″ centers. The diameter of the platen 12 is approximately 22″ to fit within and seal against the inner walls of a 55 gallon drum. For sealing purposes, two O-rings 60 are attached to the outer periphery of the platen 12. The internal cavity 32 is generally funnel shaped and converges toward the intake passage 34, which has a diameter of 2¾″. This illustrative example is suitable for pumping silicone, at a viscosity of 300,000-400,000 centipoise and room temperature, from a 55 gallon drum.

In operation, the follower 10 is inserted into a vertically oriented drum (not shown) to extract the viscous material. The follower is driven down into the drum by a suitable actuator 70 with the perforated member 14 facing into the open end of the drum. The actuator 70 may take any suitable form, such as a pneumatic, hydraulic, electric or gravity driven actuator, for example. As schematically shown with arrows 72, the actuator 70 can move the pump follower in either direction. The viscous material is thereby forced through the material openings or holes 30 in the perforated member 14, into the cavity 32 and through the intake passage 34 to the pump 36. The pump 36 directs the material to a dispenser 38.

When the follower 10 reaches the bottom of the drum and is extracted from the drum, the pump 36 will be stopped and the cavity 32 will be filled with residual or leftover viscous material. The drum may or may not contain a liner bag which holds the viscous material. If the drum includes a liner bag, the perforated member 14 provides the added advantage of preventing the liner bag from being suctioned into cavity 32 and pump intake 34. The platen 12 may be lowered into the lined or unlined drum such that the perforated member is very close to the bottom of the drum, e.g., about ½″. The residual viscous material will not drop back through the material openings 30. Instead, the viscosity of the material will cause it to be retained within the cavity 32 and against the upper side or inside face 14a of the perforated member 14. Thus, there will be very little residual material left in the drum or container upon withdrawal of the follower 10. After the platen 12 is withdrawn, a second, filled container of the viscous material may be placed beneath the pump follower and the pump follower with the retained material of the first container is placed into the second container. The process then repeated with the retained, residual material being initially pumped as the pump follower is driven into the second container. Therefore the holes 30 of the perforated member need to be sized such that the material can pass through them as the platen 12 is forced towards the bottom of the container, but will prevent the material from flowing back through by gravity as the platen 12 is withdrawn from the container. In one embodiment, the perforated member 14 is a screen.

While the present invention has been illustrated by a description of various preferred embodiments and while these embodiments have been described in some detail, it is not the intention of the Applicants to restrict or in any way limit the scope of the appended claims to such detail. Additional advantages and modifications will readily appear to those skilled in the art. The various features of the invention may be used alone or in any combination depending on the needs and preferences of the user. This has been a description of the present invention, along with the preferred methods of practicing the present invention as currently known. However, the invention itself should only be defined by the appended claims. What is claimed is:

1. Apparatus for capturing a viscous material from a container, the follower comprising:
a platen including a first side with a cavity communicating with an intake passage adapted to be fluidly coupled to a pump; and
a perforated member attached to said first side and positioned over said cavity, said perforated member having a plurality of holes allowing passage of the viscous material through said perforated member and into said cavity and said intake passage;
wherein insertion of said platen into the container forces the viscous material through the attached perforated member to fill said cavity, and said perforated member retains viscous material in said cavity upon extraction of said platen and attached perforated member from the container.

2. The apparatus of claim 1, wherein said perforated member is releasably attached to said platen.

3. The apparatus of claim 2, further comprising:
a mounting ring coupling said perforated member to said platen.

4. The apparatus of claim 1, wherein said perforated member further comprises a perforated plate.

5. The apparatus of claim 1, further comprising a pump fluidly coupled to said intake passage for pumping the viscous material from the container.

6. A method of pumping viscous material from a container with reduced material waste, the method comprising:
inserting a pump follower including a platen and a perforated member covering an internal cavity of the platen into the container with the perforated member contacting the viscous material;
driving the platen and perforated member against the material to force the material through the perforated member and into the internal cavity;
pumping the material from the internal cavity;
retracting the pump follower from the container; and
retaining residual material within the internal cavity and against the perforated member.

7. The method of claim 5, wherein the viscous material comprises a material at room temperature and having a viscosity of at least about 10,000 centipoises.

8. The method of claim 5, wherein pumping the material further comprises delivering the material to a dispenser.

9. The method of claim 6, further comprising:
stopping the pump;
removing the pump follower from the container with the retained residual material;
inserting the pump follower into a second container of the viscous material;
driving the platen and perforated member against the material in the second container to force the material through the perforated member and into the internal cavity;
pumping the residual material from the internal cavity;
retracting the pump follower from the second container; and
retaining residual material from the second container within the internal cavity and against the perforated member.
